(19) United States
(12) Patent Application Publication
(10) Pub. No.: US 2020/0327496 A1
(43) Pub. Date: Oct. 15, 2020

(54) DELIVERY MANAGEMENT SYSTEM

(71) Applicant: TOYOTA JIDOSHA KABUSHIKI KAISHA, Toyota-shi (JP)

(72) Inventors: Kohei OHTSUKA, Tokyo (JP); Atsushi SAJIKI, Okazaki-shi (JP); Yukio UMEMURA, Tokyo (JP); Takashi NANBU, Tokyo (JP); Hiroki TABATA, Tokyo (JP); Hiroki HAGIWARA, Tokyo (JP); Takeshi SAOTOME, Tokyo (JP); Masao HITOMI, Toyota-shi (JP); Yu NISHIKATA, Tokyo (JP); Kousuke MATSUYAMA, Tokyo (JP); Maiko EGUCHI, Tokyo (JP); Seiji KUROKI, Tokyo (JP); Hiroaki KAWAHARA, Tokyo (JP)

(73) Assignee: TOYOTA JIDOSHA KABUSHIKI KAISHA, Toyota-shi (JP)

(21) Appl. No.: 16/843,342

(22) Filed: Apr. 8, 2020

(30) Foreign Application Priority Data
Apr. 11, 2019 (JP) 2019-075702

(51) Int. Cl. G06Q 10/08; G06Q 10/06

(52) U.S. Cl. CPC G06Q 10/08345; G06Q 10/0838; G06Q 10/06312; G06Q 10/08355

(57) ABSTRACT

A delivery management system includes: an acceptance unit configured to accept a delivery request including information on a delivery date of a package, from a user, a setting unit configured to set a delivery fee, in which a discount according to the delivery date is applied, for the delivery request; a delivery schedule storage unit configured to store a delivery schedule of each of a plurality of delivery vehicles; and a determination unit configured to determine a delivery vehicle that delivers the package corresponding to the delivery request based on the delivery schedule such that a requirement of the delivery date of the delivery request is satisfied.

### TECHNICAL FIELD

The present disclosure relates to a delivery management system.

### CROSS-REFERENCE TO RELATED APPLICATION

This application claims the benefit of priority from Japanese Patent Application No. 2019-075702, filed Apr. 11, 2019, the entire contents of which are incorporated herein by reference.

### BACKGROUND

In the related art, a system for setting a different delivery fee depending on the presence or absence or the number of redelivery requests, is known (for example, refer to Japanese Unexamined Patent Publication No. 2005-216199).

### SUMMARY

As in the system described above, by setting a delivery fee in accordance with the presence or absence or the number of redelivery, efforts of a delivery company and burdens of expenses can be reduced. However, if the basic delivery fee is fixed, since an amount of delivery items fluctuates, it becomes difficult to dispatch a delivery vehicle. For example, there may occur a shortage of the delivery vehicles during a peak time when delivery requests (including package collection requests when a collection is required, the same applies hereinafter) are concentrated.

Therefore, an object of the present disclosure is to provide a delivery management system that can suppress the occurrence of a situation in which it is difficult to dispatch a delivery vehicle.

A delivery management system according to an aspect of the present disclosure includes: an acceptance unit configured to accept a delivery request including information on a delivery date of a package, from a user; a setting unit configured to set a delivery fee, in which a discount in accordance with the delivery date is applied, for the delivery request; a delivery schedule storage unit configured to store a delivery schedule of each of a plurality of delivery vehicles; and a determination unit configured to determine a delivery vehicle that delivers the package corresponding to the delivery request based on the delivery schedule such that a requirement of the delivery date of the delivery request is satisfied.

The delivery management system described above accepts the delivery request including information on the delivery date from the user, and determines the delivery vehicle to deliver the package such that the requirement of the delivery date of the package corresponding to the delivery request is satisfied. In this way, in a range in which the requirements of the delivery date of the package is satisfied, the delivery request can be associated with the delivery vehicle. Furthermore, the delivery management system sets a delivery fee in which a discount in accordance with the delivery date is applied. As a result, a user who has a margin time to the delivery date can be guided to set the delivery date as late as possible. As a result, the association between the above-described delivery request and the delivery vehicle can be performed with a higher degree of freedom. Therefore, according to the delivery management system described above, it is possible to appropriately suppress the occurrence of a situation in which it is difficult to dispatch a delivery vehicle.

The delivery management system described above may further include: an expected delivery amount storage unit configured to store an expected delivery amount for each future period based on past delivery results; and a presentation unit configured to determine a delivery fee for each period based on the expected delivery amount for each period, and present the delivery fee for each period to the user. According to this, the delivery fee for each period can be appropriately determined based on the expected delivery amount. For example, in order to achieve the leveling of the package distribution (deliver amount), the delivery fee for each period can be determined such that the delivery fee for the period in which the expected delivery amounts is large (expected busy periods) becomes higher than the delivery fee for the periods in which the expected delivery amounts are small (expected non-busy periods). In addition, such a delivery fee for each period is presented to the user. In this way, a user trying to make a delivery request during the expected busy period can be guided to make a delivery request (that is, a delivery request including information corresponding to the delivery date in a case of being delivered in the expected non-busy period) with the expected non-busy period, which is a period after the expected busy period, as the delivery time. As a result, it is possible to suppress the concentration of the delivery amount in the expected busy period, and to achieve the leveling of the delivery amount for each period.

According to the present disclosure, it is possible to provide a delivery management system that can suppress the occurrence of a situation in which it is difficult to dispatch a delivery vehicle.

### BRIEF DESCRIPTION OF THE DRAWINGS

FIG. 1 is a configuration diagram of a delivery management system according to an embodiment.

FIG. 2 is a flowchart illustrating an example of an operation by the delivery management system.

### DETAILED DESCRIPTION

Hereinafter, an embodiment of the present disclosure will be described with reference to the drawings. In the drawings, the same reference numerals will be given to the same or corresponding elements, and the description thereof will not be repeated.

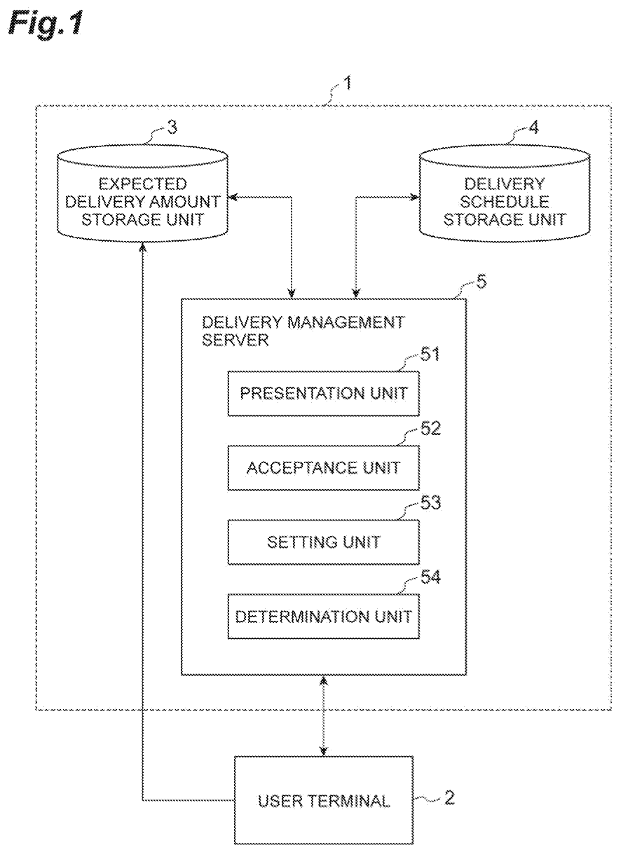

FIG. 1 is a configuration diagram of a delivery management system 1 according to an embodiment of the present disclosure. As illustrated in FIG. 1, the delivery management system 1 is a system that accepts a package delivery request from a user and determines a delivery vehicle to deliver the package. The delivery management system 1 is, for example, a computer system managed by a delivery company that provides a user with a package delivery service using a plurality of delivery vehicles. In this embodiment, as an example, the delivery management system 1 accepts a delivery request from a user terminal 2 owned by the user. The delivery vehicle is, for example, a vehicle such as a truck having a cargo compartment. The delivery management system 1 includes an expected delivery amount storage unit 3, a delivery schedule storage unit 4, and a delivery management server 5.

The user terminal 2 is a terminal owned by a user who makes a delivery request to the delivery management system 1. For example, the user can make the delivery request to the delivery management system 1 using a dedicated application installed on the user terminal 2 or a dedicated website of the delivery company (a web page displayed by a browser installed on the user terminal 2).

The expected delivery amount storage unit 3 stores an expected delivery amount for each future period based on past delivery results. The expected delivery amount storage unit 3 is, for example, a database server or the like that is communicably connected to the delivery management server 5 via any communication network. The past delivery result is, for example, delivery result information relating to a delivery amount indicating the number of delivery requests from the user and an amount of delivery targeted packages in any past period (for example, several months). The expected delivery amount for each period can be calculated, for example, as follows. First, the above-described delivery results are aggregated for a certain period (for example, time slot, day, week, month, or the like). In this way, for example, if “a day (a day of the week)” is set as a certain period, an average amount of the delivery results for each day of the week can be obtained as the expected delivery amount for the above-described each period. In addition, if a “time slot (for example, one hour unit)” is set as a certain period, an average amount of the delivery results for each time slot can be obtained as an expected delivery amount for each of the above-described period. In addition, if “a period specified by a combination of a day and a time slot” is set as a certain period, an average amount of the delivery results for each day of the week and for each time slot can be obtained as an expected delivery amount for each of the above-described period.

The delivery schedule storage unit 4 stores a delivery schedule of each of the plurality of delivery vehicles. The delivery schedule storage unit 4 is, for example, a database server or the like that is communicably connected to the delivery management server 5 via any communication network. The delivery schedule stored in the delivery schedule storage unit 4 is, for example, information indicating a vehicle dispatch plan set by the delivery company. For example, the delivery schedule includes information such as a delivery route of each of the plurality of delivery vehicles managed by the delivery company and a scheduled time of arrival at each location on the delivery route. A delivery vehicle that delivers or collects the packages according to a predetermined travel route (e.g. a delivery vehicle that performs a so-called milk run) may be included in the plurality of delivery vehicles.

The delivery management server 5 is configured with a computer including a processor such as a central processing unit (CPU) and a memory such as a read only memory (ROM) or a random access memory (RAM). The delivery management server 5 includes a presentation unit 51, an acceptance unit 52, a setting unit 53, and a determination unit 54.

The presentation unit 51 determines a delivery fee for each period based on the expected delivery amount for each period stored in the expected delivery amount storage unit 3, and presents the delivery fee for each period to the user. For example, the presentation unit 51 may set the delivery fee for an expected busy period in which the expected delivery amount expected based on the past delivery results is relatively large (for example, a period during which the expected delivery amount is equal to or larger than a predetermined threshold value d1) to be higher than a standard fee set in advance. On the other hand, the presentation unit 51 may set the delivery fee for an expected non-busy period in which the expected delivery amount is relatively small (for example, a period during which the expected delivery amount is less than a predetermined threshold value d2) to be lower than the standard fee. Here, a relationship of “d1>d2” is established between the threshold value d1 and the threshold value d2.

As described above, by changing the delivery fee for each period in accordance with the expected delivery amount, the delivery amount can be leveled. Specifically, a user (a client) who has a relatively large time margin until a delivery date can request the collection and/or delivery in the expected non-busy period in order to keep the delivery fee low. More specifically, a user who considers that the date and time at which the package arrives at a delivery destination is allowed to be later than the standard delivery date can request the collection and/or delivery during the expected non-busy period (for example, the next day or a period after tomorrow), which is after a standard delivery period (for example, the current day or the next day). As a result, it is possible to suppress the concentration of the delivery requests during the expected busy period.

The presentation unit 51 presents the delivery fee for each period determined as described above to the user. For example, the presentation unit 51 uploads a delivery fee for each period to the dedicated application and/or the dedicated website. In this way, the user can check the delivery fee for each period via the user terminal 2.

The acceptance unit 52 accepts a delivery request including the information on the delivery date of the package from the user. For example, the user terminal 2 accepts the user's operation input of the delivery request and transmits the delivery request input by the user to the delivery management server 5. The acceptance unit 52 accepts the delivery request by receiving the delivery request from the user terminal 2.

The delivery request includes information necessary for delivering the packages. For example, the delivery request may include the following information in addition to the delivery date of the package. That is, the delivery request may include information such as package information relating to the package to be delivered, an address of the package collection place, an address of the delivery destination, and information on a contact point of the user (the client). The package information can include information such as a size, type, and nature of the package (e.g. whether or not it is fragile, necessity of a refrigerated transportation service, or the like.).

The information on the delivery date may be information directly indicating the delivery date or information indirectly indicating the delivery date. The information directly indicating the delivery date is, for example, information indicating when the package should be delivered to the delivery destination (that is, information on a latest allowable arrival date and time). The information indirectly indicating the delivery date is, for example, information for specifying a period during which the collection and/or delivery is performed. For example, after checking the delivery fee for each period presented by the presentation unit 51 as described above, the user can make the delivery request for the collection and/or the delivery during a period that is later than a standard period (hereinafter, “specific period”). In this case, the delivery request actually includes the information on the delivery date when the collection and/or the delivery during the specific period is performed.

The setting unit 53 sets the delivery fee to the delivery request, to which a discount in accordance with the delivery date is applied. For example, the setting unit 53 calculates a standard delivery date based on the information included in the delivery request (for example, the size, type, and nature of the package to be delivered, and the address of the package collection place and the delivery destination). For example, the setting unit 53 can hold table information that defines the correspondence between a combination of the above-described information and the standard delivery date in advance, and then, can calculate the standard delivery date corresponding to the delivery request referring to the table information.

Then, If the delivery date (hereinafter, “designated delivery date”) included in the delivery request is a date that is later (future) than the standard delivery date (hereinafter, “standard delivery date”), the setting unit 53 determines a discount rate in accordance with the margin period from the standard delivery date to the designated delivery date. The setting unit 53 can hold, for example, table information that defines the correspondence between the margin period and the discount rate in advance, and then, can determine the discount rate in accordance with the margin period referring to the table information. For example, in some cases, as the margin period increases, handling of the delivery request can be postponed, which may be convenient for the delivery company. In such a case, the discount rate may be set such that the discount rate increases as the margin period increases. The setting unit 53 can set the delivery fee (delivery fee in which the discount is applied) for the delivery request by applying the determined discount rate to the standard delivery fee set in advance.

If the information on the delivery date included in the delivery request is a date in which the above-described specific period is designated, the setting unit 53 may determine the discount rate in accordance with the margin period from the standard delivery date to the delivery date (hereinafter, “specific delivery date”) when the collection and/or the delivery in the above-described specific period is performed.

The determination unit 54 determines a delivery vehicle that delivers the package corresponding to the delivery request based on the delivery schedule for each delivery vehicle stored in the delivery schedule storage unit 4 such that the requirements of the delivery date in the delivery request can be satisfied for each delivery request. That is, the determination unit 54 determines the delivery vehicle that handles each delivery request (that is, the delivery vehicle that performs the collection and/or the delivery) such that the requirements of each delivery date in the plurality of delivery requests accepted from a plurality of users by the acceptance unit 52 is satisfied. In addition, a maximum amount of the package that can be loaded on each delivery vehicle is determined in advance in accordance with the size of a loading platform. Therefore, the determination unit 54 determines the delivery vehicle that delivers the package corresponding to each of the plurality of delivery requests such that the loaded amount of the package for each delivery vehicle does not exceed the maximum amount. That is, the determination unit 54 allocates the packages corresponding to each delivery request to a package loading space of each delivery vehicle such that each requirement of the delivery date in the delivery request is satisfied and that the requirement (not to exceed the maximum amount) of the loaded amount of the package for each delivery vehicle is satisfied. For example, the determination unit 54 can determine the delivery vehicle that delivers the package corresponding to each delivery request by solving such an allocation problem using a known optimization algorithm.

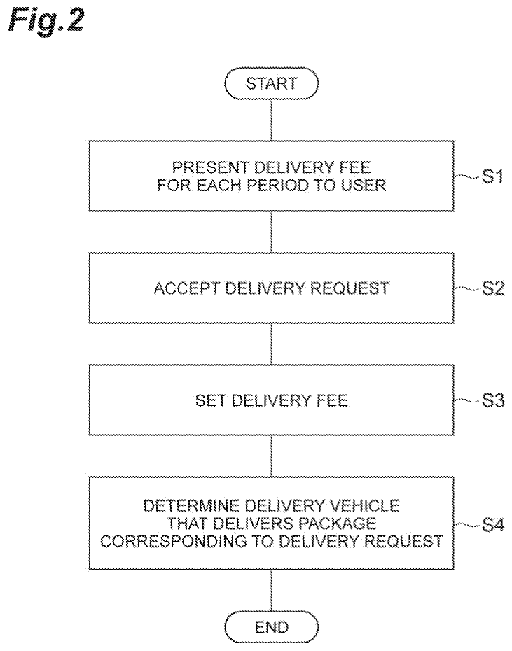

FIG. 2 is a flowchart illustrating an example of the operation by the delivery management system 1. As illustrated in FIG. 2, first, the presentation unit 51 presents a delivery fee for each period to the user (step S1). For example, the user confirms the delivery fee for each period via the user terminal 2. Subsequently, the acceptance unit 52 accepts a delivery request including information on the delivery date of the package from the user (Step S2). For example, the acceptance unit 52 receives, for example, the delivery request input by the user to the user terminal 2, from the user terminal 2. Subsequently, the setting unit 53 sets a delivery fee in which the discount in accordance with the delivery date is applied, to the delivery request accepted in step S2 (step S3). Subsequently, the determination unit 54 determines a delivery vehicle that delivers the package corresponding to the delivery request based on the delivery schedule for each delivery vehicle stored in the delivery schedule storage unit 4, such that the requirements of the delivery date in the delivery request is satisfied for each delivery request (Step S4).

The delivery management system 1 described above accepts the delivery request including information on the delivery date from the user, and determines the delivery vehicle to deliver the package such that the requirement of the delivery date of the package corresponding to the delivery request is satisfied. In this way, in a range in which the requirements of the delivery date of the package is satisfied, the delivery request can be associated with the delivery vehicle. Furthermore, the delivery management system 1 sets a delivery fee in which a discount in accordance with the delivery date has been applied. As a result, a user who has a margin time to the delivery date can be guided to set the delivery date as late as possible. As a result, the association between the above-described delivery request and the delivery vehicle (the processing in the determination unit 54) can be performed with a higher degree of freedom. Therefore, according to the delivery management system 1, it is possible to appropriately suppress the occurrence of a situation in which it is difficult to dispatch a delivery vehicle.

The effects described above will be supplemented. In the related art, in a delivery request accepted from a user does not always include information on a delivery date as described above. For this reason, it is common practice that an order of delivery (priority of delivery) is determined in an order of delivery request (order of acceptance), and the delivery vehicle that delivers the package corresponding to each delivery request is determined based on the order of delivery. On the other hand, in the delivery management system 1, by acquiring the delivery request including the information on the delivery date, the determination unit 54 can freely change the orders of delivery between the delivery requests within a range in which the requirements of the delivery date of each delivery request is satisfied. For example, for the collection and/or the delivery of the package corresponding to the delivery request having a relatively long margin period, the determination unit 54 can postpone the handling of collection and/or delivery. In this way, as described above, it is possible to associate the delivery request with the delivery vehicle with a higher degree of freedom than before.

Furthermore, the delivery management system 1 includes the expected delivery amount storage unit 3 that stores the expected delivery amount for each future period based on the past delivery results, and the presentation unit 51 that determines the delivery fee for each period based on the expected delivery amount for each period and presents the delivery fee for each period to the user. According to this, the delivery fee for each period can be appropriately determined based on the expected delivery amount. For example, in order to achieve the leveling of the package distribution (deliver amount), the delivery fee for each period can be determined such that the delivery fee for the period in which the expected delivery amounts is large (expected busy periods) becomes higher than the delivery fee for the periods in which the expected delivery amounts are small (expected non-busy periods). In addition, such a delivery fee for each period is presented to the user. As a result, a user trying to make a delivery request during the expected busy period in a normal case (in other words, in a case in which there is no difference in the delivery fee for each period), can be guided to make a delivery request (that is, a delivery request including information corresponding to the delivery date in a case of being delivered in the expected non-busy period) with the expected non-busy period, which is a period after the expected busy period, as the delivery time. As a result, it is possible to suppress the concentration of the delivery amount in the expected busy period, and to achieve the leveling of the delivery amount for each period.

As described above, the embodiment of the present disclosure have been described, but the present disclosure is not limited to the above-described embodiment. The present disclosure can be implemented in various modifications without departing from the gist of the claims.

For example, the delivery fee for each period determined by the presentation unit 51 in the above embodiment may be determined based on another policy not described in the above embodiment. For example, the presentation unit 51 may set the delivery fee for the period during which the collection and or the delivery that is in accordance with the above-described milk run schedule is possible and there is a margin in the expected delivery amount, be lower than the standard. This is because it is preferable for the delivery company to be able to handle as many delivery requests as possible using only the delivery vehicles that performs the milk run. In other words, it is preferable for the delivery company to reduce the required number of delivery vehicles (special vehicles) other than the delivery vehicle that performs the milk run as much as possible.

What is claimed is:

1. A delivery management system comprising:
an acceptance unit configured to accept a delivery request including information on a delivery date of a package, from a user;
a setting unit configured to set a delivery fee, in which a discount in accordance with the delivery date is applied, for the delivery request;
a delivery schedule storage unit configured to store a delivery schedule of each of a plurality of delivery vehicles; and
a determination unit configured to determine a delivery vehicle that delivers the package corresponding to the delivery request based on the delivery schedule such that a requirement of the delivery date of the delivery request is satisfied.

2. The delivery management system according to claim 1, further comprising:
an expected delivery amount storage unit configured to store an expected delivery amount for each future period based on past delivery results; and
a presentation unit configured to determine a delivery fee for each period based on the expected delivery amount for each period, and present the delivery fee for each period to the user.
